(19) United States
(12) Patent Application Publication
(10) Pub. No.: US 2020/0198198 A1
(43) Pub. Date: Jun. 25, 2020

(54) PROCESS FOR PLASTIC OVERMOLDING ON A METAL SURFACE AND PLASTIC-METAL HYBRIDE PART

(71) Applicant: DSM IP ASSETS B.V., Heerlen (NL)

(72) Inventors: Frank Peter Theodorus Johannes VAN DER BURGT, Echt (NL); Ruogu LIAO, Echt (NL)

(21) Appl. No.: 16/621,067

(22) PCT Filed: Jun. 11, 2018
(86) PCT No.: PCT/EP2018/065394

§ 371 Date: Dec. 10, 2019

(30) Foreign Application Priority Data
Jun. 14, 2017 (EP) 17175983.0
Jun. 16, 2017 (CN) PCT/CN2017/088641

(51) Int. Cl. B29C 45/14; B32B 15/088

(52) U.S. Cl. CPC B29C 45/14311; B32B 15/088; B29K 2077/00; B29C 2045/14803; B29C 2045/14868

(57) ABSTRACT

The invention relates to a process for manufacturing a plastic-metal hybrid part by overmolding of a moldable plastic material on a metal surface via nano-molding technology (NMT), wherein the moldable plastic material is a LDS composition comprising an LDS additive and a blend of a semi-crystalline semi-aromatic polyamide and an amorphous semi-aromatic polyamide. The invention also relates to a plastic-metal hybrid part, obtainable by said process, wherein a metal part is overmolded by a LDS composition comprising a blend of a semi-crystalline semi-aromatic polyamide and an amorphous semi-aromatic polyamide.

The invention relates to a process for manufacturing a plastic-metal hybrid part by plastic overmolding of a metal surface via nano-molding technology (NMT). More particular the invention relates to a process wherein the metal is overmolded with an LDS (laser direct structuring) composition. The invention also relates to a plastic-metal hybrid part obtained by a nano-molding technology (NMT) process, wherein the hybrid part comprises a plastic material comprising a LDS (laser direct structuring) additive bonded to a surface area of a metal part. In particular the present invention concerns a plastic-metal hybrid part, obtained by a nano-molding technology (NMT) process, and comprising a conductive circuit obtained by an LDS process.

Nano-molding technologies and laser direct structuring are processes and technologies to produce products with integrated functions and/or integrated components. Combination of these processes can lead to further integration of different functions and miniaturization of products.

Electrical components may be provided as molded integrated devices (MID) with desired printed conductors. In contrast to conventional circuit boards made of fiberglass-reinforced plastic or the like, MID components manufactured in this way can be three-dimensional molded parts having an integrated conductor layout and possibly further electronic or electromechanical components mounted there upon. The use of MID components of this type, even if the components have only printed conductors and are used to replace conventional wiring inside an electrical or electronic device, saves space, allowing the relevant device to be made smaller, and lowers the manufacturing costs by reducing the number of assembly and contacting steps. It is becoming increasingly popular to form MIDs using a laser direct structuring (LDS) process. Laser Direct Structuring (LDS) is a process that enables an injection molded article to be selectively plated with metal to form discrete conductive circuit paths. First, a plastic article is injection molded using a polymer composition formulated specifically for this process. The plastic article is then activated with a laser in the desired pattern, thereby selectively activating the surface of the article in the areas traced with the laser. The plastic article then undergoes an electroless plating process, with a metal such as copper, nickel or gold, with the resulting circuit paths conforming exactly to the laser pattern. In the LDS process a computer-controlled laser beam travels over the MID to activate the plastic surface at locations where the conductive path is to be situated. With such a process, it is possible to obtain small conductive path widths (such as of 150 microns or less) as well as area's. In addition, the spacing between the conductive paths may also be small. As a result, MIDs formed from this process save space and weight in the end-use applications. One advantage of the Laser Direct Structuring (LDS) process is the ability to have a circuit path following the contour of the injection molded article, thus applying a true 3D circuit path. By integrating the circuit directly onto the plastic article, the designer now has freedoms previously unavailable. These design freedoms allow article consolidation, weight reduction, miniaturization, reduced assembly time, improved reliability and overall system cost reduction. Another advantage of laser direct structuring is its flexibility. If the design of the circuit is changed, it is simply a matter of reprogramming the computer that controls the laser.

Nano-molding technology is a technology wherein a plastic material is bonded to a metal part to form a so-called plastic-metal hybrid part, wherein the bonding strength at the metal-plastic interface results from or is enhanced by a pretreatment of the metal resulting in a surface area with surface irregularities of nano-size dimensions. Such irregularities have dimensions in the range of about a few nanometers up to a few hundreds of nanometers and suitably have a shape of ultrafine asperities, recesses, projections grains and pores.

For the NMT metal pretreatment different technologies and different combinations of treatment steps can be applied. An NMT process that is mostly used is the process comprising a so-called “T-treatment”. In the “T-treatment” developed by Taisei Plas, the metal is fine etched with an aqueous solution of a water soluble amine, such as ammonia or hydrazine. Generally, such solutions are applied with a pH of around 11. Such a process is described, for example, in patent applications US-20060257624A1, CN-1717323-A, CN-1492804-A, CN-101341023-A, CN-101631671-A, and US-2014065472A1. In the latter document the aluminum alloy obtained after the etching step in the aqueous ammonia or hydrazine solution had a surface characterized by ultrafine asperities of 20 to 80 nm period or ultrafine recesses or projections of 20 to 80 nm.

Another NMT metal pretreatment method comprises an anodizing treatment. In the anodizing treatment, the metal is anodized in an acidic solution to form a corroded layer with a porous metal oxide finish to form a kind of interpenetrated structure with the plastic material. Such a process is described, for example, in patent applications US-20140363660-A1 and EP-2572876-A1. In the latter document an example of an aluminum alloy formed by anodizing is described which is covered with a surface having holes, the openings of which have a number average inner diameter of 10 to 80 nm as measured under electron microscope observation. Anodizing may also be applied after the plastic is already overmolded on the metal. Anodizing pacifies the surface and also gives it the nice finish.

Each of these processes may be combined with multiple steps, for example in combination with other etching, neutralizing and rinsing steps, and/or with the use of a primer, applied on the metal substrate prior to the metal substrate being overmolded with the plastic material. Finally, the metal part is inserted into a mold wherein resin is injected and bonded directly on the treated surface.

In the NMT process as developed by TaiseiPlas, a metal sheet is etched by dipping the metal sheet into an alkaline solution. The alkaline solution is indicated as T-solution and the dipping step is indicated as T-treatment step.

According to U.S. Pat. No. 8,858,854-B1, the anodizing treatment has specific advantages over NMT processes comprising multi-stage pretreatment steps wherein the metal part is subjected to multiple chemicals baths including degreasing agents, acid solutions, base solutions, and lastly submerged in a T-solution and rinsed in diluted water. In the terminology of U.S. Pat. No. 8,858,854-B1, NMT is limited to the process including the T-treatment step.

In the present invention, with the terms “nano-molding technology (NMT)” and “NMT process”, is understood any overmolding of a metal subjected to a pretreatment process that results in metal a surface area with surface irregularities of nano-size dimensions, and thus includes both the anodizing method of U.S. Pat. No. 8,858,854-B1 and the T-treatment solution of Taisei Plas, as well as other alternatives.

The polymers most widely used in plastic-metal hybrid parts made by NMT technology are polybutylene terephthalate (PBT) and polyphenylene sulfide (PPS). In US patent application US-2014065472-A1/U.S. Pat. No. 9,166,212-B1 it is mentioned that “when the resin composition contained PBT or PPS as the main component, optionally compounded with a different polymer, and further contained 10 to 40 mass % of a glass fiber, it exhibited very strong joining strength with aluminum alloy. In the condition where the aluminum and resin composition were both plate shaped and joined to each other in an area of 0.5 to 0.8 cm² the shear fracture was 25 to 30 MPa. In the case of a resin composition where different polyamides were compounded the shear fracture was 20 to 30 MPa.” For the preparation of the metal surfaces in the plastic-metal hybrid parts of US-2014065472A1/U.S. Pat. No. 9,166,212B1 a “T-treatment” step, followed by an additional amine adsorption step were applied.

In patent application EP-2572876-A1, mentioned here before, a polyamide composition, comprising PA-66/6T/61 (in the wt. ratio 12/62/26) and 30 wt. % glass fibers, was applied on different NMT metal surfaces. Where the metal treatment comprised a T-treatment, the pore size was 25 nm. In case of anodizing treatment the pore size was 17 nm. For both hybrid systems, the bonding force was measured to be 25.5 MPa.

In view of the increasing importance of miniaturization and automation of processes, there is a need for reducing the number of parts in assembled products, for integrating of functions of different parts and for improving the connection between different parts in such assemblies. The NMT process provides a very useful technology for combining plastic parts and metal parts being assembled by an integrated process, comprising shaping and assembling in one step, by overmolding of a plastic material on a metal surface while simultaneously arriving at a reasonable bonding force via nano-molding technology.

Processes and products which combine NMT and LDS are known from CN-105694447-A. This patent application describes a polyamide resin composition used for NMT (nano molding technology) and having LDS (laser direct structuring) function. The composition comprises a polyamide, a laser direct structuring additive and optionally further components, like glass fiber, inorganic crystal whiskers, stabilizing agent, toughening agent, and lubricant. The polyamide is a semi-aromatic semi-crystalline polyamide (PPA), such as PA9T, PA6T/61/66 or PA6T/6.

With a semi-aromatic semi-crystalline polyamide (PPA) as the polyamide the bonding force obtained in NMT is not optimal. The presence of a LDS (laser direct structuring) additive may have a further adverse effect on the bonding force. Thus, there is a need for improving the bonding force and for extending the technology to other materials in order to enable the exploitation of said technology more widely.

Therefore the aim of the present invention has been to provide a process and plastic-metal hybrid parts resulting thereof, wherein the bonding strength is increased.

This aim has been achieved with the process according to the invention and with the plastic-metal hybrid parts according to the invention and obtainable by such process.

The process according to the invention is directed to the manufacturing of a plastic-metal hybrid part by overmolding an LDS composition on a metal surface via nano-molding technology (NMT), comprising steps of
(i) providing a metal substrate having a surface area with surface irregularities of nano-size dimensions;
(ii) providing an LDS composition;
(iii) forming a plastic structure on the metal substrate by molding said LDS composition directly on at least a part of the surface area with the surface irregularities of the metal substrate;
wherein the LDS composition comprises an LDS additive, a semi-crystalline semi-aromatic polyamide and an amorphous semi-aromatic polyamide.

The effect of the process according to the invention, wherein in the LDS composition comprises a blend of a semi-crystalline semi-aromatic polyamide (sc-PPA) and an amorphous semi-aromatic polyamide (am-PPA) is used, is that the bonding force at the interface between the metal part and the plastic part is increased, compared to the corresponding LDS composition only comprising the sc-PPA next to the LDS additive.

Herein the LDS composition is suitably molded on at least a part of the surface area with surface irregularities of nano-size dimensions. The metal substrate may also have multiple surface areas with surface irregularities of nano-size dimensions, in which at least one surface area, or at least a part thereof is overmolded with the LDS composition.

For the metal substrate having a surface area with surface irregularities of nano-size dimensions, any metal substrate suitable for NMT technology may be employed in the present invention.

The pretreatment process applied for preparing the metal substrate used in the process according to the invention, may by any process suitable for preparing a surface area with surface irregularities of nano-size dimensions. Suitably, such a process comprises multiple pretreatment steps. Suitably, the pretreatment steps, applied in the NMT process comprise one or more pretreatment steps selected from the group consisting of
treatment with a degreasing agent;
treatment with an alkaline etching material;
treatment with an acid neutralizing agent;
treatment with an aqueous solution of a water soluble amine;
treatment with an oxidative component;
an anodizing step; and
treatment with a primer material.

In the embodiment wherein the NMT process comprises a step comprising treatment with an aqueous solution of a water soluble amine (so called T-treatment), the aqueous solution preferably is an aqueous ammonium or hydrazine solution.

In the embodiment wherein the NMT process comprises a pretreatment step of anodizing the metal substrate, any anodizing agent suitable for this purpose can be used. Preferably, the anodizing agent is selected from the group consisting of chromic acid, phosphoric acid, sulfuric acid, oxalic acid, and boric acid. In case a primer material is used, said primer material is suitably selected from the group consisting of organosilane, titanate, aluminate, phosphate, and zirconate.

Also other pretreatment methods may be applied to create a surface with a nano-size microstructure, for example laser treatment.

The pretreatment process suitably comprises one or more rinsing steps in between subsequent pretreatment steps.

The nano-size surface irregularities suitably comprise asperities, recesses, projections, grains or pores, or any combination thereof. Also suitably, the nano-size surface irregularities have dimensions in the range of 10-100 nm. Dimensions include width, length, depth, height, diameter of a part of the irregularity.

According to a preferred embodiment of the process, after the step of forming a plastic structure on the metal substrate, the so-formed plastic-metal hybrid part is subjected to an annealing step, wherein the plastic-metal hybrid part is kept for at least 30 minutes at a temperature between the glass transition temperature and the melting temperature of the LDS composition.

According to another preferred embodiment of the process, after the step of forming a plastic structure on the metal substrate, the so-formed plastic-metal hybrid part is subjected to an annealing step, wherein the plastic-metal hybrid part is kept for at least 30 minutes at a temperature between 140° C. and 270° C., preferably between 150° C. and 250° C., or even between 160° C. and 230° C.

The process according to the invention suitably combines steps for the NMT bonding process and steps for the laser direct structuring (LDS) process. This combination constitutes a preferred embodiment. According to this embodiment, the process comprises, next to steps (i)-(iii), steps of
(iv) subjecting a surface area of the plastic structure formed on the metal substrate to a laser beam, thereby activating the surface area subjected to the laser beam, and
(v) subjecting the plastic-metal hybrid part comprising an activated surface area obtained by step (iv) to an electroless plating process, thereby forming a metal based conductive pattern on the activated surface area.

The metal based conductive pattern can be used as a conductive circuit for further electrical and/or electronic components mounted onto or connected to the plastic-metal hybrid part. The advantage of this preferred embodiment is that a molded integrated device (MID) comprising a conductive circuit, an isolating plastic material and a metal substrate can be formed in a limited number of steps, while at the same time the adhesion between plastic and the metal is improved.

The metal substrate in the process according to the invention can in principle be any metal substrate that can be modified by a pretreatment process and be overmolded by a plastic material. The metal substrate will typically be selected and shaped according to the requirements of the projected use. Suitably, the metal substrate is a stamped sheet metal substrate. Also the metal of which the metal substrate is composed may be chosen freely. Preferably, the metal substrate is formed from, or consists of a material selected from the group consisting of aluminum, aluminum alloy (for example 5052 aluminum), titanium, titanium alloy, iron, steel (for example stainless steel), magnesium, and magnesium alloy.

The composition used in the process according to the invention, and in the plastic-metal hybrid part according to the invention, comprises an LDS additive and a blend of a semi-crystalline semi-aromatic polyamide (sc-PPA) and an amorphous semi-aromatic polyamide (am-PPA). Herein the sc-PPA and the am-PPA can be used in amounts varying over a wide range.

With the term semi-crystalline polyamide is herein understood a polyamide that has crystalline domains as demonstrated by the presence of a melting peak with a melting enthalpy of at least 5 J/g. With the term amorphous polyamide is herein understood a polyamide that has no crystalline domains or essentially so, as demonstrated by absence of a melting peak or the presence of a melting peak with a melting enthalpy of less than 5 J/g. Herein the melting enthalpy is expressed relative to the weight of the polyamide.

With a semi-aromatic polyamide is herein understood a polyamide derived from monomers comprising at least one monomer containing an aromatic group and at least one aliphatic or cycloaliphatic monomer.

The semi-crystalline semi-aromatic polyamide suitably has a melting temperature around 270° C., or above. Preferably the melting temperature (Tm) is at least 280° C., more preferably in the range of 280-350° C., or even better 300-340° C. A higher melting temperature can generally be achieved by using a higher content in an aromatic monomer for example terephthalic acid and/or shorter chain diamines in the polyamide, for example linear C4-C6 diamines. The person skilled in the art of making polyamide molding compositions will be capable of making and selecting such polyamides.

Suitably, the semi-crystalline semi-aromatic polyamide has a melting enthalpy of at least 15 J/g, preferably at least 25 J/g, and more preferably at least 35 J/g. Herein the melting enthalpy is expressed relative to the weight of the semi-crystalline semi-aromatic polyamide.

With the term melting temperature is herein understood the temperature, measured by the DSC method according to ISO-11357-1/3, 2011, on pre-dried samples in an N₂ atmosphere with heating and cooling rate of 10° C./min. Herein Tm has been calculated from the peak value of the highest melting peak in the second heating cycle. With the term melting enthalpy is herein understood the melting enthalpy measured by the DSC method according to ISO-11357-1/3, 2011, on pre-dried samples in an N₂ atmosphere with heating and cooling rate of 10° C./min. Herein the melting enthalpy is measured from the integrated surface below the melting peak(s) in the second heating cycle. With the term glass transition temperature (Tg) is herein understood the temperature, measured by the DSC method according to ISO-11357-1/2, 2011, on pre-dried samples in an N₂ atmosphere with heating and cooling rate of 10° C./min. Herein the Tg is calculated from the value at the peak of the first derivative (with respect of time) of the parent thermal curve corresponding with the inflection point of the parent thermal curve for the second heating cycle. Suitably, the semi-aromatic polyamide used in the present invention is derived from about 10 to about 75 mole % of the monomers containing an aromatic group. Accordingly, preferably about 25 to about 90 mole % of the remaining monomers are aliphatic and/or cycloaliphatic monomers.

Examples of suitable monomers containing aromatic groups are terephthalic acid and its derivatives, isophthalic acid and its derivatives, naphthalene dicarboxylic acid and its derivatives, C₆-C₂₀ aromatic diamines, p-xylylenediamine and m-xylylenediamine.

Preferably, the composition according to the invention comprises a semi-crystalline semi-aromatic polyamide derived from monomers comprising terephthalic acid or one of its derivatives.

The semi-crystalline semi-aromatic polyamide can further contain one or more different monomers, either aromatic, aliphatic or cycloaliphatic. Examples of aliphatic or cycloaliphatic compounds from which the semi-aromatic polyamide may further be derived include aliphatic and cycloaliphatic dicarboxylic acids and its derivatives, aliphatic C₄-C₂₀ alkylenediamines and/or C₆-C₂₀ alicyclic diamines, and amino acids and lactams. Suitable aliphatic dicarboxylic acids are, for example, adipic acid, sebacic acid, azelaic acid and/or dodecanedioic acid. Suitable diamines include butanediamine, hexamethylenediamine; 2 methylpentamethylenediamine; 2-methyloctamethylenediamine; trimethylhexamethylene-diamine; 1,8-diaminooctane, 1,9-diaminononane; 1,10-diaminodecane and 1,12-diaminododecane. Examples of suitable lactams and amino acids are 11-aminododecanoic acid, caprolactam, and laurolactam.

Examples of suitable semi-crystalline semi-aromatic polyamides include poly(m-xylylene adipamide) (polyamide MXD,6), poly(dodecamethylene terephthalamide) (polyamide 12,T), poly(decamethylene terephthalamide) (polyamide 10,T), poly(nonamethylene terephthalamide) (polyamide 9,T), hexamethylene adipamide/hexamethylene terephthalamide copolyamide (polyamide 6,T/6,6), hexamethylene terephthalamide/2-methylpentamethylene terephthalamide copolyamide (polyamide 6,T/D,T), hexamethylene adipamide/hexamethylene terephthalamide/hexamethylene isophthalamide copolyamide (polyamide 6,6/6,T/6,1), poly(caprolactam-hexamethylene terephthalamide) (polyamide 6/6,T), hexamethylene terephthalamide/hexamethylene isophthalamide (polyamide 6,T/6,1) copolymer, polyamide 10,T/10,12, polyamide 10T/10,10 and the like.

Preferably, the semi-crystalline semi-aromatic polyamide is a polyphthalamide, represented by the notation PA-XT or PA-XT/YT, wherein the polyamide is built from repeat units derived from terephthalic acid (T) and one or more linear aliphatic diamines. Suitable example thereof are PA-8T, PA-9T, PA-10T, PA-11T, PA5T/6T, PA4T/6T, and any copolymers thereof.

In a preferred embodiment of the invention, the semi-crystalline semi-aromatic polyamide has a number average molecular weight (Mn) of more than 5,000 g/mol, preferably in the range of 7,500-50,000 g/mol, more preferably 10,000-25,000 g/mol. This has the advantage that the composition has a good balance in mechanical properties and flow properties.

Examples of suitable amorphous semi-aromatic polyamides are PA-XI, wherein X is an aliphatic diamine, and amorphous copolyamides thereof (PA-XI/YT), such as PA-61 and PA-81, and PA-61/6T or PA-81/8T (for example PA-61/6T 70/30).

Preferably, the amorphous semi-aromatic polyamide comprises, or consists of amorphous PA-61/6T.

For the LDS process, the goal is the production of a conductive path on a molded part through formation of a laser etched surface, and formation of a plated metal layer during a subsequent plating process. The conductive path can be formed by electroless plating process e.g. by applying a standard process, such as a copper plating process. Other electroless plating processes that may be used include, but are not limited to, gold plating, nickel plating, silver plating, zinc plating, tin plating or the like. In such a process laser radiation activates the polymer surface for the subsequent plating process. When an article comprising an LDS additive is exposed to the laser, its surface is activated. Without being bound by a theory, it seems that during activation with the laser metal complexes break down to metal nuclei. The laser draws a circuit pattern onto the part and leaves behind a roughened surface containing embedded metal particles. These particles act as nuclei for the plating process and enable adhesion of the metallization layer in metallization process. Plating rate and adhesion of the plated layer are key evaluation requirements.

The LDS additive is selected to enable the composition to be used in a laser direct structuring process. In an LDS process, an article made of the thermoplastic composition comprising the LDS additive is exposed to a laser beam to activate metal atoms from the LDS additive at the surface of the thermoplastic composition. As such, the LDS additive is selected such that, upon exposure to a laser beam, metal atoms are activated and exposed and in areas not exposed to the laser beam, no metal atoms are exposed. In addition, the LDS additive is selected such that, after being exposed to a laser beam, the etching area is capable of being plated to form conductive structure. As used herein “capable of being plated” refers to a material wherein a substantially uniform metal plating layer can be plated onto a laser-etched area and show a wide process window for laser parameters.

Examples of LDS additives useful in the present invention include, but are not limited to, spinel based metal oxides and copper salts, or a combination including at least one of the foregoing LDS additives. Examples of suitable copper salts are copper hydroxide phosphate, copper phosphate, copper sulfate, cuprous thiocyanate. Spinel based metal oxides are generally based on heavy metal mixtures, such as in copper chromium oxide spinel, e.g. with formula CuCr2O4, nickel ferrite, e.g. spinel with formula NiFe2O4, zinc ferrite, e.g. spinel with formula ZnFe2O4, and nickel zinc ferrite, e.g. spinel with formula ZnₓNi₍₁₋ₓ₎Fe2O4 with x being a number between 0 and 1.

In a preferred embodiment, the LDS additive is a heavy metal mixture oxide spinel, more particular a copper chromium oxide spinel or a nickel zinc ferrite, or a combination thereof. Suitably, the nickel zinc ferrite is a spinel with formula ZnₓNi₍₁₋ₓ₎Fe2O4 with x being a number in the range of 0.25-0.75.

The LDS additive (C) is suitably present in amount in the range of 1.0-10 wt. %. More particular, the amount is in the range from 2 to 9.5 wt. %, or in the range of 3 to 9 wt. %, or even 4 to 8.5 wt. %, relative to the total weight of the composition.

Suitably, the LDS additive, the sc-PPA and the am-PPA are comprised by the LDS composition in the following amounts:

(A) 30-89 wt. % of the semi-crystalline semi-aromatic polyamide,

(B) 10-40 wt. % of the amorphous semi-aromatic polyamide, and

(C) 1-10 wt % of an LDS additive.

Herein the weight percentages wt, % are relative to the total weight of the composition, and the sum of components A-C is at most 100 wt. %.

Next to the LDS additive, the sc-PPA and the am-PPA, the composition may comprise other components.

In a preferred embodiment of the invention the LDS composition comprises a reinforcing agent (component D). Herein the reinforcing agent suitable comprises fibers (D1), or fillers (D2), or a combination thereof. More particular the fibers and fillers are preferably selected from materials consisting of inorganic material. Examples thereof include the following fibrous reinforcing materials: glass fibers, carbon fibers, and mixtures thereof. Examples of suitable inorganic fillers that the composition may comprise, include one or more of glass beads, glass flakes, kaolin, clay, talc, mica, wollastonite, calcium carbonate, silica and potassium titanate.

Fibers are herein understood to be materials having an aspect ratio L/D (length/diameter) of at least 10. Suitably, the fibrous reinforcing agent has an L/D of at least 20. Fillers are herein understood to be materials having an aspect ratio L/D of less than 10. Suitably, the inorganic filler has an L/D of less than 5. In the aspect ratio L/D, L is the length of an individual fiber or particle and D is the diameter or width of an individual fiber or particle.

The reinforcing agent is suitably present in an amount in the range of 5-60 wt. %, relative to the total weight of the composition. Suitably, the amount of component D is in a more restricted range of 10-50 wt. %, more particular 20-40 wt. %, relative to the total weight of the composition.

In a special embodiment of the present invention, the component D in the composition comprises 5-60 wt. % of a fibrous reinforcing agent (D1) having an L/D of at least 20 and 0-55 wt. % of an inorganic filler (D2) having an L/D of less than 5, wherein the combined amount of (D1) and (D2) is 60 wt. % or less, and wherein the weight percentages are relative to the total weight of the composition.

Preferably, component D comprises a fibrous reinforcing agent (D1) and optionally an inorganic filler (D2), wherein the weight ratio (D1):(D2) is in the range of 50:50-100:0.

Also preferably, the reinforcing agent comprises, or even consists of glass fibers. In a particular embodiment the composition comprises 5-60 wt. %, of glass fibers, more particularly 10-50 wt. %, even more particularly 20-40 wt. %, relative to the total weight of the composition.

In a preferred embodiment, the LDS composition comprises:

(A) 30-80 wt. % of the semi-crystalline semi-aromatic polyamide;
(B) 10-30 wt. % of the amorphous semi-aromatic polyamide;
(C) 1-10 wt % of the LDS additive; and
(D) 5-60 wt. % of a fibrous reinforcing agent or a filler, or a combination thereof.

Herein the weight percentages wt, % are relative to the total weight of the composition, and the sum of components A-D is at most 100 wt. %.

The composition can comprise, next to components A-C and optionally D, mentioned above, one or more further components. Such components may be selected from auxiliary additives and any other component suitable for use in the plastic-metal hybrid part. The amount thereof can also be varied over a wide range. The one or more further components are together referred to as component E.

In this respect the composition suitably comprises at least one component selected from flame retardant synergists and auxiliary additives for thermoplastic molding compositions known by one skilled in the art suitable to improve other properties. Suitable auxiliary additives include acid scavengers, plasticizers, stabilizers (such as, for example, thermal stabilizers, oxidative stabilizers or antioxidants, light stabilizers, UV absorbers and chemical stabilizers), processing aids (such as, for example, mold release agents, nucleating agents, lubricants, blowing agents), pigments and colorants (such as, for example, carbon black, other pigments, dyes), and antistatic agents.

An example of a suitable flame retardant synergist is zinc borate. By the term “zinc borate” is meant one or more compounds having the formula (ZnO)ₓ(B₂O₃)_{Y}(H₂O)_{z}.

Suitably, the amount of component E is in the range of 0-30 wt. %. Correspondingly, the combined amount of A-D suitably is at least 70 wt. %. Herein all the weight percentages (wt. %) are relative to the total weight of the composition.

The total amount of other components E can be, for example, about 1-2 wt. %, about 5 wt. %, about 10 wt. %, or about 20 wt. %. Preferably, the composition comprises at least one further component, and the amount of E is in the range of 0.1-20 wt. %, more preferably 0.5-10 wt. %, or even 1-5 wt. %. Correspondingly, components A-D are present in a combined amount in the range of 80-99.9 wt. %, 90-99.5 wt. %, respectively 95-99 wt. %.

In preferred embodiment, the LDS composition consist of
(A) 30-70 wt. % of the semi-crystalline semi-aromatic polyamide;
(B) 10-30 wt. % of the amorphous semi-aromatic polyamide;
(C) 1-10 wt. % of the LDS additive;
(D) 10-55 wt. % of a fibrous reinforcing agent or a filler, or a combination thereof; and
(E) 0.1-20 wt. % of at least one other component.

Herein the weight percentages wt, % are relative to the total weight of the composition, and the sum of A-E is 100 wt. %.

The present invention also relates to a plastic-metal hybrid part comprising a plastic material bonded to a surface area of a metal part, obtained by a nano-molding technology (NMT) process. In the plastic-metal hybrid part according to the invention the plastic material is a LDS composition comprising at least an LDS additive and a blend of a semi-crystalline semi-aromatic polyamide and an amorphous semi-aromatic polyamide.

The plastic-metal hybrid part according to the invention may be any metal hybrid part, obtainable by the process according to the invention or any particular or preferred embodiment or modification thereof as described herein above.

The LDS composition in the plastic-metal hybrid part according to the invention can be any LDS composition comprising the LDS additive and said blend and any particular or preferred embodiment or modification thereof as described herein above.

In a particularly preferred embodiment, the plastic-metal hybrid part has a bonding force between the metal part and the plastic material, measured by the method according to ISO19095 at 23° C. and a tensile speed of 10 mm/min, in the range of 40-70 MPa, for example in the range of 45-65 MPa. The bonding force can be, for example, about 50 MPa, or about 55 MPa, or below, or between, or above said values. The higher the bonding force the more versatile and flexible the product designer can design the plastic-metal hybrid part.

The invention furthermore relates to a plastic-metal hybrid part, wherein the plastic material comprises a surface area comprising a metal based conductive pattern. This plastic-metal hybrid part is obtainable with the process according to the invention comprising the NMT steps (i)-(iii) and the LDS steps (iv)-(v). Use of the LDS composition as according to the invention, i.e. comprising, next to the LDS additive, a blend of a semi-crystalline semi-aromatic polyamide (sc-PPA) and an amorphous semi-aromatic polyamide (am-PPA) allows for the preparation of an MID in an highly effective manner, while the bonding force at the interface between the metal part and the plastic part the plastic-metal hybrid part is increased, compared to the corresponding plastic-metal hybrid part made of an LDS composition only comprising the sc-PPA next to the LDS additive.

The plastic-metal hybrid part according to the present invention, and the various embodiments thereof, are suitably used in medical applications, automotive applications, aerospace applications, military applications, antennas, sensors, security housings and connectors. Therefore, the invention also relates to antennas, sensors, security housings and connectors comprising a plastic-metal hybrid part according to the present invention. The invention is in particular suited for applications wherein an electrical and electronic functions are integrated with a structural metal part, for example antennas or sensors integrated with a metal back frame or middle frame for mobile electronic devices.

The invention is further illustrated with the following Examples and Comparative Experiments.

### Materials

| | |
|---|---|
| sc-PPA-A | semi-crystalline semi-aromatic polyamide, PA6T/4T/66 |
| | based, melting temperature 325° C., glass transition |
| | temperature 125° C.; aliphatic polyamide, PA-46, |
| | melting temperature 295° C. |
| am-PPA-A | amorphous semi-aromatic polyamide, PA6I6T, glass |
| | transition temperature 150° C.; |
| GF | Glass fibers, standard grade for thermoplastic polyamides |
| Miscellaneous | Color master batch Cabot PA3785 (carbon black) (MB) |
| LDS additive | CuCrOx spinel (Shephard black 1G) |
| Metal plates A: | Aluminum plates, grade AI6063, measuring 18 mm × 45 |
| | mm × 1.6 mm; pretreated by a process comprising: |
| | degreasing with ethanol, etching with an alkaline |
| | solution, neutralizing with an acidic solution, |
| | and fine etching with an aqueous ammonia solution |
| | (so-called T-treatment). |

### Preparation of Compositions

Two LDS compositions based on sc-PPA-A were prepared according to the formulations of Comparative Experiment A and Example I in Table 1. The preparations were carried out in a twin screw extruder using standard compounding conditions.

Overmolding of Metal Plates-A with Compositions According to Comparative Experiments A-C and Examples I-V

Test samples were prepared by overmolding the metal plates after putting the metal plates in a mold set at 140° C. and injecting the LDS composition from an injection molding machine at a melt temperature of 345° C.

After injection molding of the LDS composition and thus forming of the metal hybrid parts, the resulting metal-plastic hybrid parts were demolded.

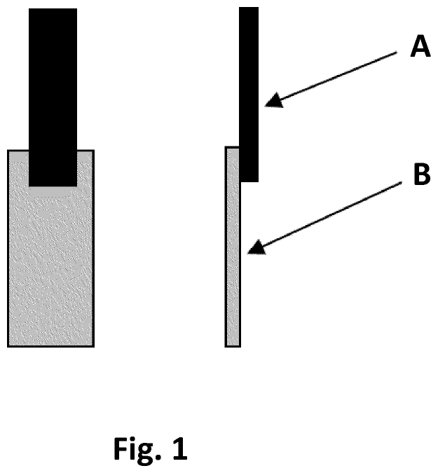

The test samples had the following dimensions: The size of the plates was 18 mm×45 mm×1.6 mm. The size of the plastic part was 10 mm×45 mm×3 mm. The overlapping bonding area was 0.482 cm². The shape and relative position of the metal part and plastic part are schematically shown in FIG. 1.

FIG. 1. Schematic representation of the test samples, wherein the black part (A) is the plastic part, and the grey part (B) is the metal part.

### BONDING STRENGTH TEST METHOD

The bonding strength methods for the adhesion interface in the plastic-metal assemblies was measured by the method according to ISO19095 at 23° C. and a tensile speed of 10 mm/min. The results have been included in Table 1.

### LDS Performance

The LDS behavior was tested with a 20 W laser, applying different power levels ranging from 50% to 90% of the maximum laser power (max 20 W) and different pulsing frequencies (60 kHz, 80 kHz and 100 kHz), with a laser spot size of 40 μm diameter. Plating was done with a standard Ethone Plating bath with Cu only with a plating time of 10 minutes. Plating thickness was measured with 300 micron diameter X-ray beam, averaged over 3 different measurements for each of the process conditions. The measurements were based on calibrated data for copper films with certified thickness values. Results are given in Table 1.

TABLE 1
Compositions and test results for Comparative Experiment
A and Example I on aluminum plates (metal plates A).

| | CE-C | EX-I |
|---|---|---|
| Composition (wt. %) | | |
| sc-PPA | 53 | 33 |
| am-PPA | 0 | 20 |
| GF | 40 | 40 |
| LDS additive | 5 | 5 |
| Color MB | 2 | 2 |
| Total | 100 | 100 |
| Test Results | | |
| Bonding Strength (MPa) | Moderate | Good |
| Metal plating | Good | Good |

The results show that the bonding strength for the composition according to the invention (Example I) comprising the amorphous semi-aromatic polyamide is better than for those for the corresponding Comparative Experiment A.

1) Process for manufacturing a plastic-metal hybrid part by plastic overmolding of a Laser Direct Structuring (LDS) composition on a metal surface via nano-molding technology (NMT), comprising steps of
(i) providing a metal substrate having a surface area with surface irregularities of nano-size dimensions;
(ii) providing an LDS composition;
(iii) forming a plastic structure on the metal substrate by molding said LDS composition directly on at least a part of the surface area with the surface irregularities of the metal substrate;
wherein the LDS composition comprises a Laser Direct Structuring (LDS) additive, a semi-crystalline semi-aromatic polyamide and an amorphous semi-aromatic polyamide.

2) Process according to claim 1, comprising steps of
(i) subjecting a surface area of the plastic structure formed on the metal substrate to a laser beam, thereby activating the surface area subjected to the laser beam, and
(ii) subjecting the plastic-metal hybrid part comprising an activated surface area obtained by step (iv) to an electroless plating process, thereby forming a metal based conductive pattern on the activated surface area.

3) Process according to claim 1, wherein the metal substrate is a stamped sheet metal substrate.

4) Process according to claim 1, wherein the metal substrate is formed from a material selected from the group consisting of aluminum, aluminum alloy, titanium, titanium alloy, iron, steel, magnesium, and magnesium alloy.

5) Process according to claim 1, wherein the process comprises a step prior to step i) of anodizing the metal substrate using an anodizing agent selected from the group consisting of chromic acid, phosphoric acid, sulfuric acid, oxalic acid, and boric acid.

6) Process according to claim 1, wherein the LDS composition comprises
(A) 30-89 wt. % of the semi-crystalline semi-aromatic polyamide;
(B) 10-40 wt. % of the amorphous semi-aromatic polyamide; and
(C) 1-10 wt. % of the LDS additive,
wherein the weight percentages (wt. %) are relative to the total weight of the composition.

7) Process according to claim 1, wherein the LDS composition comprises
(A) 30-80 wt. % of the semi-crystalline semi-aromatic polyamide;
(B) 10-30 wt. % of the amorphous semi-aromatic polyamide;
(C) 1-10 wt. % of the LDS additive, and
(D) 5-60 wt. % of a fibrous reinforcing agent or a filler, or a combination thereof;
wherein the weight percentages (wt. %) are relative to the total weight of the LDS composition.

8) Process according to claim 1, wherein the LDS composition consists of
(A) 30-70 wt. % of the semi-crystalline semi-aromatic polyamide;
(B) 10-30 wt. % of the amorphous semi-aromatic polyamide;
(C) 1-10 wt. % of the LDS additive;
(D) 10-60 wt. % of a fibrous reinforcing agent or a filler, or a combination thereof; and
(E) 0.1-20 wt. % of at least one other component;
wherein the weight percentages wt. % are relative to the total weight of the composition.

9) Process according to claim 1, wherein the LDS additive comprises a spinel based metal oxide.

10) Plastic-metal hybrid part comprising a plastic material bonded to a metal part with a surface area having surface irregularities of nano-size dimensions, wherein the plastic material is a Laser Direct Structuring (LDS) composition comprising an LDS additive, a semi-crystalline semi-aromatic polyamide, and an amorphous semi-aromatic polyamide.

11) Plastic-metal hybrid part obtained by the process according to claim 1.

12) Plastic-metal hybrid part obtained by the process according to claim 6.

13) Plastic-metal hybrid part claim 10, wherein the plastic-metal hybrid part has a bonding force between the metal part and the plastic material, measured by the method according to ISO19095 at 23° C. and a tensile speed of 10 mm/min, in the range of 40-70 MPa.

14) Plastic-metal hybrid part according to claim 10, wherein the plastic material comprises a surface area comprising a metal based conductive pattern.

15) Plastic-metal hybrid part according to claim 10, wherein the part is a part for in medical applications, automotive applications, aerospace applications, military applications, RF antennas, sensors, security housings and connectors.
